(19) United States
(12) Patent Application Publication
(10) Pub. No.: US 2019/0208302 A1
(43) Pub. Date: Jul. 4, 2019

(54) FLUID-FILLED EAR TIP

(71) Applicant: Knowles Electronics, LLC, Itasca, IL (US)

(72) Inventors: Christopher Monti, Elgin, IL (US); Thomas Miller, Arlington Heights, IL (US); Erik Wiederholtz, St. Charles, IL (US)

(21) Appl. No.: 16/236,376

(22) Filed: Dec. 29, 2018

Related U.S. Application Data
(60) Provisional application No. 62/611,900, filed on Dec. 29, 2017.

(51) Int. Cl. H04R 1/10

(52) U.S. Cl. CPC H04R 1/1016; H04R 1/1058

(57) ABSTRACT

An ear tip includes a body member that forms an internal chamber. The body member has an exterior portion configured to contact at least a portion of an ear canal of a user of the ear tip. The internal chamber has a nominal volume when the internal chamber is not deformed. A fluid is disposed in the internal chamber of the body member where a volume of the fluid-filled internal chamber is less than the nominal volume when the fluid-filled internal chamber is deformed.

### RELATED APPLICATIONS

This application relates to U.S. Provisional Patent Application Ser. No. 62/611,900 filed on Dec. 29, 2017, and entitled “Fluid-Filled Ear Tip,” the entire contents of which is hereby incorporated by reference.

### TECHNICAL FIELD

This disclosure relates to ear tips that are adaptable to a user's ear.

### BACKGROUND

Hearing devices such as headphones, earphones or buds, hearing aids and other sound emitting devices provide sound to an ear canal of a wearer. In some use cases it is desirable to prevent sound from a surrounding environment from entering the ear canal. To do so, noise cancellation components and/or processing techniques may be implemented. For example, noise cancellation may be performed actively using a digital signal processor, but this approach is complex and costly. Alternatively environmental sound may be isolated by at least partially sealing the ear canal with an ear tip of the sound emitting device.

Ear tips are typically made from foam or silicone. While foam ear tips may provide adequate acoustic isolation, they tend to degrade quickly and must be replaced frequently. Also some users find foam tips to be uncomfortable, especially during extended use. Solid silicone ear tips are more robust and may be more comfortable relative to foam ear tips. However, solid silicone ear tips provide low sound damping and may have poor seal performance.

### BRIEF DESCRIPTION OF THE DRAWINGS

For a more complete understanding of the disclosure, reference should be made to the following detailed description and accompanying drawings wherein:

FIG. 1 is a perspective view of a fluid-filled ear tip;

FIG. 2 is a cross-sectional view of the fluid-filled ear tip of FIG. 1;

FIG. 3 is a cross-sectional view of an ear tip in a stretched configuration;

FIG. 4 is a cross-sectional view of an ear tip inserted at least partially into an ear canal of a wearer;

FIG. 5 is a perspective view of another fluid filled ear tip;

FIG. 6 is a cross-sectional view of the ear tip of FIG. 5;

FIG. 7 is a cross-sectional view of the ear tip of FIG. 5 in a stretched configuration;

FIG. 8 is a cross-sectional view of the ear tip of FIG. 5 inserted at least partially into a user's ear canal;

FIG. 9 is a cross-sectional view of another ear tip embodiment;

FIG. 10 is a cross-sectional view of the ear tip of FIG. 9 coupled to a portion of a sound emitting device;

FIG. 11 is a perspective view of another ear tip;

FIG. 12 is a cross-sectional view of the ear tip of FIG. 11;

FIG. 13 is a perspective view of another embodiment of the ear tip;

FIG. 14 is a cross-sectional view of the ear tip of FIG. 13 devoid of fluid in the internal chamber; and

FIG. 15 is a cross-sectional view of the ear tip of FIG. 14 in an under-filled shape state.

Skilled artisans will appreciate that elements in the figures are illustrated for simplicity and clarity. It will be appreciated further that certain actions and/or steps may be described or depicted in a particular order of occurrence while those skilled in the art will understand that such order or sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The disclosure relates to ear tips having improved performance. Ear geometry and sensitivity to foreign objects varies considerably from person to person. Acoustic isolation requires that the ear tip have intrinsic sound damping properties and good fitting seal on the ear, while a comfortable ear tip conforms to the user's ear with the exertion of minimal pressure. The ear tips disclosed herein are configured, depending on use case requirements, to provide comfort or high acoustic isolation or both through the use of a fluid disposed within an internal chamber defined by an elastic housing or body member of the ear tip.

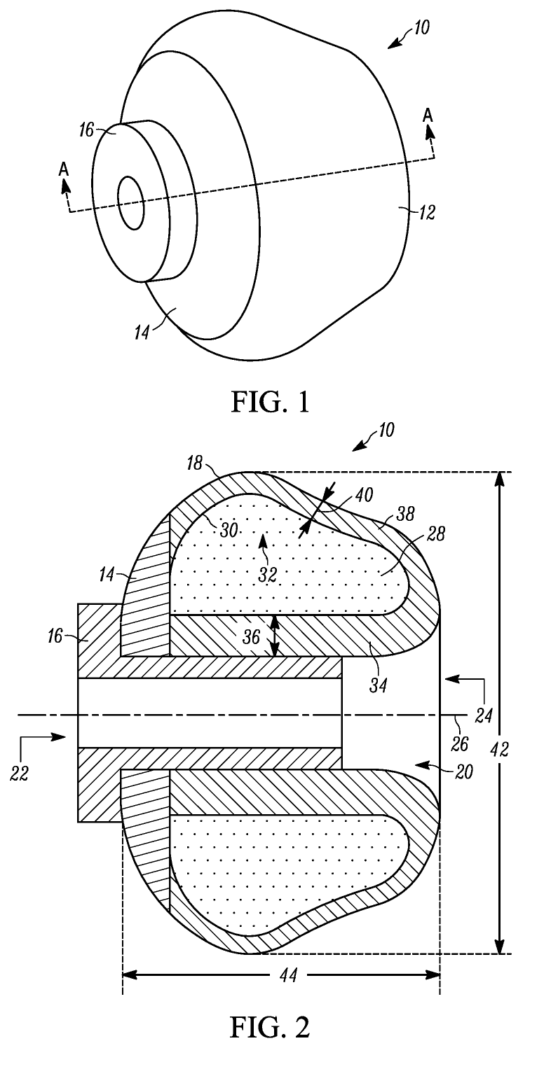

FIG. 1 is a fluid-filled ear tip 10 including a body member 12 defining an internal chamber for retaining a fluid. Generally, the body member has an exterior portion configured to contact the user's ear. In the embodiments shown, the body member is configured (e.g., sized and shaped) for insertion or disposal at least partially into the ear canal of the user. In some implementations, body members configured for at least partial insertion into the ear canal may also include structure configured to contact other portions of the ear. For example, a body member may include a lobe or other portion configured to improve retention of the body member in the ear canal. In other embodiments however the body member may be configured to contact and form at least a partial seal with portions of the ear other than the ear canal.

FIG. 2 shows a cross-sectional view of the ear tip 10 taken along the line A-A as shown in FIG. 1. The body member 12 has an exterior portion 18 configured to contact and conform to at least a portion of a user's ear canal. More generally, depending on the configuration (e.g., size and shape) of the ear tip, the exterior portion of the body member may contact some other portion of the user's ear including, but not limited to, the outer ear, inner ear, pinna, concha, tragus, intertragic notch, antitragus, antihelix, crus of helix, helix as described herein.

The body member may be manufactured from an elastomeric material. Suitable materials include but are not limited to natural rubber, butyl rubber or soft neoprene, polymer-based compounds like silicone, latex-based compounds and other natural or synthetic materials or combinations of such materials. The particular material used may depend on one or more factors including biocompatibility and non-reactiveness with other materials (e.g., the fluid), among other considerations and use case requirements.

The body member may have a hardness that lies within a broad range. In some embodiments, the hardness ranges between 5 Shore A Durometer and 50 Shore A Durometer, but this range is merely an example and is not intended to be limiting. Softer materials may provide greater comfort than harder materials. A hardness ranging from 5 Shore A Durometer to 30 Shore A Durometer will likely be most comfortable to most users. In other applications, the benefits of harder materials may outweigh the desire for comfort. Harder materials tend to be more durable and tear resistant. The hardness may also depend on material choice. For example, silicone is biocompatible, non-reactive with suitable fluids and has a hardness (e.g., 30 Shore A Durometer to 80 Shore A Durometer) within a suitable range. Other suitable materials may have a different hardness. Generally, the material of the body member has a modulus of elasticity (i.e., Young's Modulus) in a range of 0.1 MPa to 100 MPa. For example, suitable silicones have a Young's Modulus roughly on the order of 1 MPa.

In some implementations, a volume of fluid disposed in the internal chamber of the body member is less than a nominal volume of the internal chamber. The nominal volume is defined as a volume of the internal chamber in an un-deformed state. In other implementations however the volume of the fluid filled chamber is the same as the nominal volume. In other embodiments the volume of the fluid filled chamber is greater than the nominal volume (i.e., the internal chamber is over-filled by stretching the elastic body member).

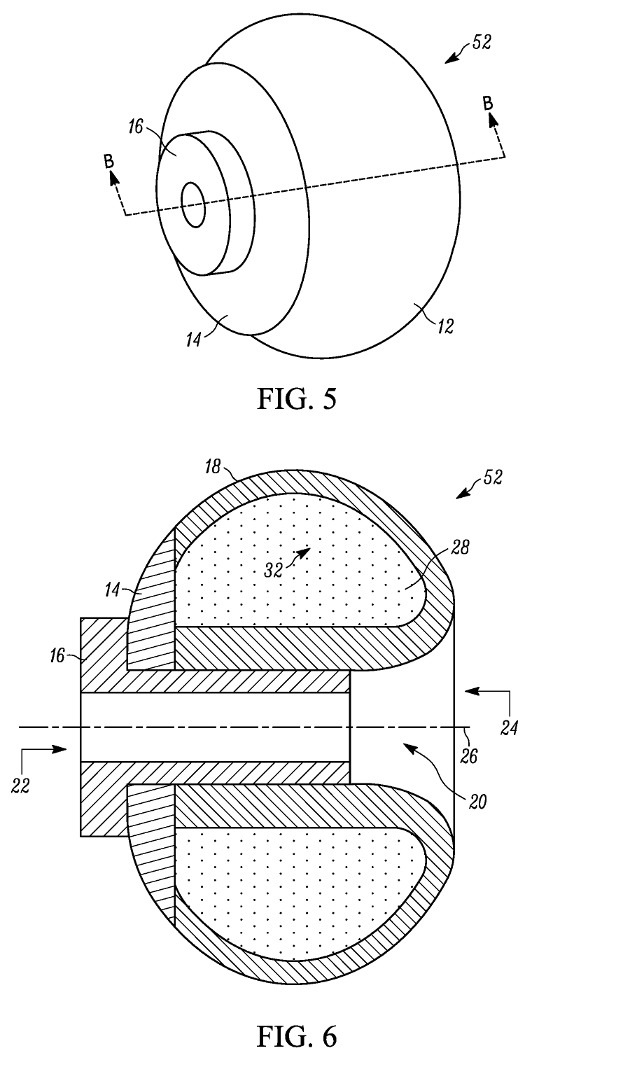

In FIG. 2, the body member 12 includes a fluid-filled internal chamber 28 defining an inner surface 30 of the body member wherein the fluid-filled internal chamber 28 has a volume that is less than a nominal volume. FIG. 14 shows a body member 60 having an un-deformed internal chamber 64 devoid of fluid wherein the internal chamber has a nominal volume. FIG. 15 also shows a body member 60 having a fluid-filled internal chamber 64 with a volume less than the nominal volume. In both FIGS. 2 and 15, the under-filled internal chamber is deformed and the pressure in the internal chamber is less than an ambient pressure outside of the internal chamber as shown in FIG. 2. FIGS. 5-6 show another embodiment where the fluid-filled internal chamber has a volume that is equal to the nominal volume. Generally, the extent to which the volume of the internal chamber is filled with fluid depends on use case requirements and may also depend on production cost considerations.

Generally the optimal fill percentage depends in part on the configuration of the ear tip, user preference and use case requirements among other considerations. As suggested sensitivity to foreign objects contacting the ear varies greatly among users and may also depend on the portion of the ear contacted by the ear tip.

In embodiments where the volume of the internal chamber of the body member is less than the nominal volume, the volume of the fluid-filled internal chamber can be 40 percent to 90 percent of the nominal volume. But this range is only an example and is not intended to be limiting. For some users, a fill percentage nearer 40 percent may provide adequate comfort and performance whereas a fill percentage nearer 90 percent may provide better comfort and performance for other users. In other embodiments, the volume of the fluid-filled internal chamber is between 50 percent and 80 percent of the nominal volume. In still other embodiments, the volume of the fluid-filled internal chamber is between 60 percent and 70 percent of the nominal volume. Manufactures may opt to provide ear tips having high, medium and low fill percentages to accommodate the demands of different user's.

In one embodiment, the internal chamber is at least partially filled with fluid via an opening that is later covered by a cap fastened to the body member to form a fluid-tight seal. Generally, some residual air may remain in the chamber after the internal chamber is at least partially filled with fluid.

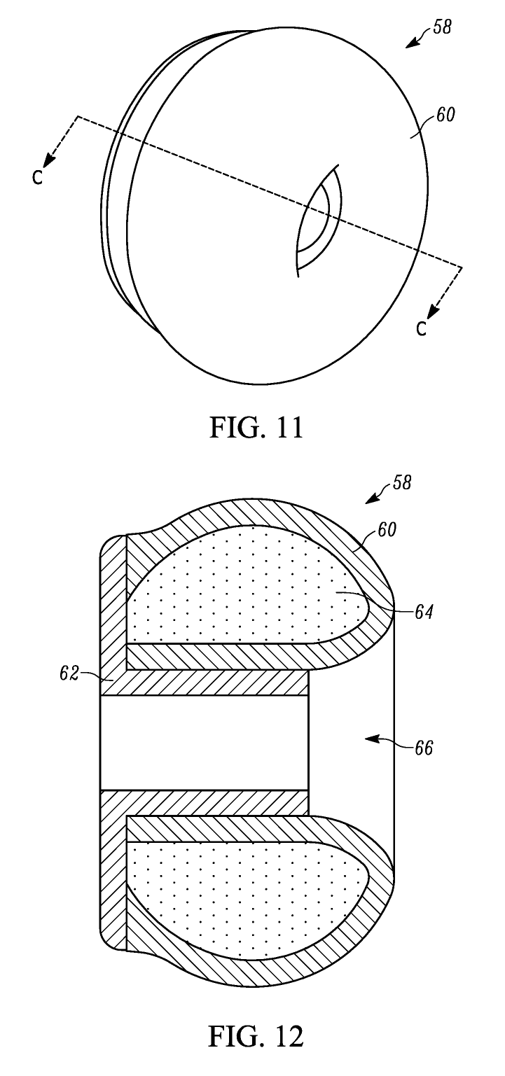

FIGS. 1-2 show such a cap 14 enclosing fluid in the internal chamber of the body member. The cap 14 may be made from the same material as the body member or from a different material, for example, a relatively hard material like plastic. In these embodiments, after depositing fluid in the internal chamber, the cap is fastened to the body member using an adhesive or other fastening means. In FIGS. 11-12, the internal chamber is enclosed by a cap 62 that is fastened to the body member. The cap 62 may also be made from the same material as the body member or from a different material like plastic.

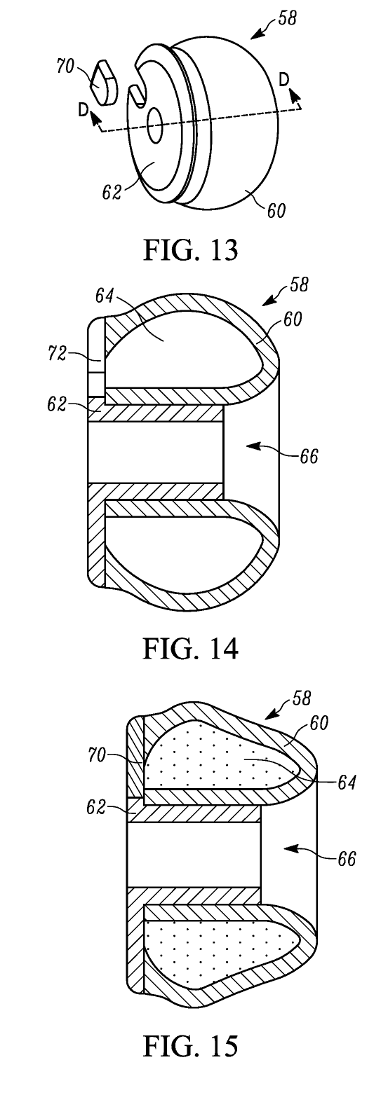

FIGS. 13-15 show an embodiment where a relatively rigid cap 62 includes a port 72 through which the internal chamber 64 may be accessed for fluid filling purposes. A cover 70 may be placed over the port 72 to enclose fluid in the internal chamber as shown in FIG. 15. The cover may be retained by a snap fit and a seal member may form a seal between the cover and cap. Alternatively, the cover may be glued or otherwise adhered to the cap. In the embodiment of FIGS. 13-15, the cap 62 may be fastened to the body member before fluid is placed into the internal chamber, and the cap 62 may be fastened to the body member by an adhesive or by other fastening means.

Alternatively, fluid may be injected into a sealed internal chamber by inserting a needle or other injection device through a wall of the body member. In some processes, air may first be removed from the internal chamber before injecting the fluid. After injection, the injection site may be sealed with a cover or cement or a combination thereof. The cover required to seal the injection site may be smaller than the cap 14 shown in FIGS. 1-2. Further, some suitable elastomeric materials may possess a self-healing property that does not require application of a cover or cement after penetration with a needle or other injection device. Thus the body member may not require a cover or cement after injection, depending on the method by which fluid is disposed in the internal chamber. Some residual air may remain in the chamber in any process after the internal chamber is at least partially filled with fluid.

A variety of fluids may be suitable for use in the internal chamber. Some considerations in selecting the fluid are compatibility and viscosity. For example, it may be desirable to use a fluid that is biocompatible and non-reactive with the material from which the body member is formed. Fluid viscosity depends in part on the configuration of the ear tip, user preferences and use case requirements among other considerations. An ear tip filled with a lower viscosity fluid will recover from deformation more quickly than an ear tip filled with a higher viscosity fluid. Also, an ear tip filled with a lower viscosity fluid will conform more readily to the user's ear and may be less resistant to insertion than a higher viscosity fluid. For some users, a lower viscosity fluid may be more comfortable than a higher viscosity fluid. Generally, the fluid viscosity may be between 1 centipoise and 10,000,000 centipoise. As suggested, ear tips having a higher viscosity fluid may require some deformation to facilitate insertion into the ear canal, examples of which are discussed further herein. One suitable fluid is petroleum jelly, which is biocompatible and non-reactive with some materials from which the body member may be formed. Saline and other solutions may be used alternatively. In other embodiments, the ear tip is filled with a fluid having a variable viscosity (i.e., a non-Newtonian fluid).

The fluid may also be mixed with a non-fluidic compound or with one or more other fluids. Mixed fluids may select for one or more fluid characteristics. Such characteristics include but are not limited to stability and viscosity among others. In one embodiment, a fluid is mixed with another fluid or with a non-fluidic powder to change its viscosity. Mixing may occur before the chamber is filled or the mixing may occur in the chamber after filling.

In some embodiments, the ear tips described herein are configured with a sound passage or a conduit that passes sound from a sound emitting device to the user's ear while blocking ambient sounds from entering the ear. Such a sound emitting device may be embodied as an active hearing device having an electro-acoustic transducer (e.g., a dynamic speaker or armature receiver). Alternatively, the sound emitting device may be embodied as a passive device, like a stethoscope, devoid of an electro-acoustic transducer. In other embodiments, the ear tip is configured as an ear plug lacking a sound passage wherein the ear plug blocks sound, debris or fluid from entering the user's ear.

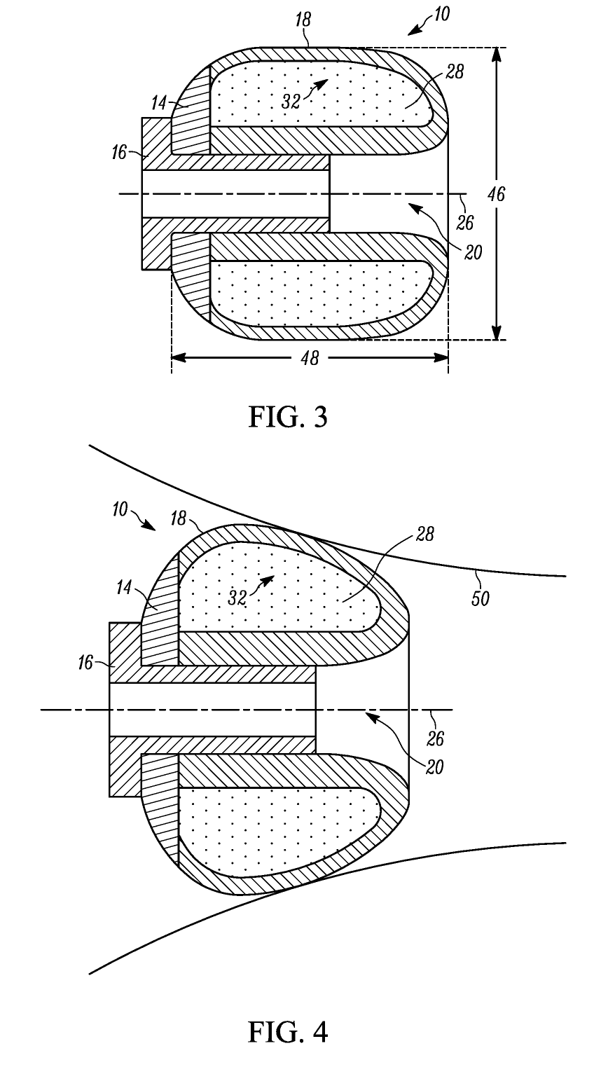

In FIG. 2, the body member includes a sound passage 20 having a sound inlet portion or sound inlet 22 and a sound outlet portion or sound outlet 24. The sound outlet is configured to provide sound received by the sound inlet to the ear canal of the user of the ear tip. FIGS. 3-15 show similar sound passages. In the embodiments shown, the sound passage 20 has a linear axial dimension and the body member has a quasi-toroidal portion disposed about the axial dimension. In other embodiments however the sound passage may be non-linear. Also, the body member is not necessarily disposed symmetrically about the axial dimension of the sound passage. For example, the shape of the body member may depend on the part of the ear with which the seal or partial seal is formed.

In FIGS. 1-8 and 10, the ear tip is shown coupled to a spout or nozzle 16 or other portion of the sound emitting device. The nozzle is typically part of the sound emitting device to which the ear tip is coupled. In alternative embodiments however a nozzle or portion thereof may be integrated with the ear tip to form an assembly as shown in FIGS. 11-13, wherein the assembly is subsequently coupled to the sound emitting device.

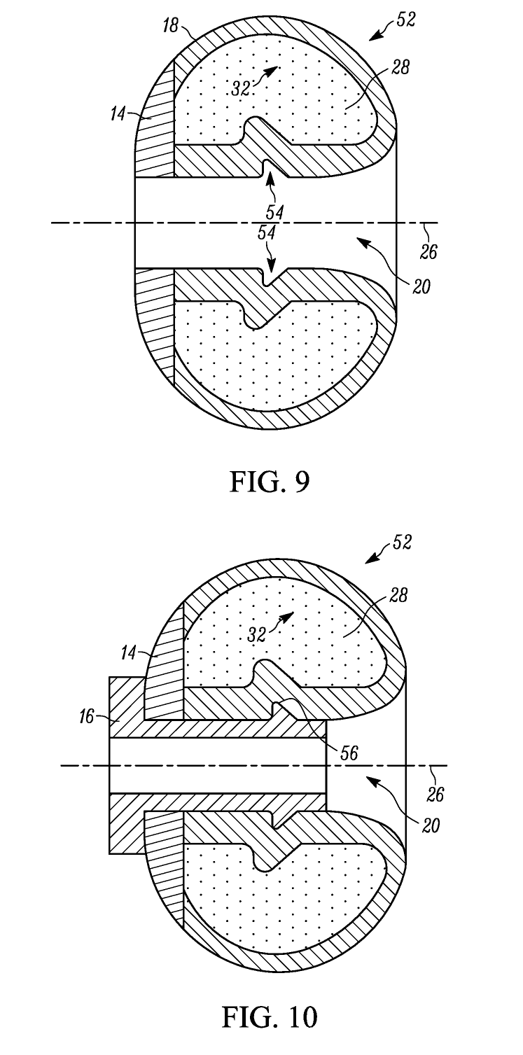

In some embodiments, a surface or feature of the sound passage near the sound inlet is configured to engage and retain a nozzle or other component that is a part of the sound emitting device or that is coupled to the sound emitting device. FIGS. 9-10 show an ear tip embodiment wherein a surface of the sound passage 20 includes a notch 54 configured to engage a complementary barb 56 on the nozzle. Alternatively, the sound passage may include a narrowing taper that engages a complementary taper on the nozzle. Mating engagement of the complementary surfaces axially positions the ear tip relative to the nozzle. In other embodiments, the nozzle includes one or more barbs but the sound passage does not include a complementary surface, wherein the ear tip is retained on the nozzle by the elastic nature of the sound passage. A key or detent may be used to rotationally align the components in embodiments where rotational alignment is required. The elastic property of the body member permits insertion of the portion of the sound emitting device (e.g., spout) into the sound passage.

In some embodiments, the elastic body member is removably coupled to a portion of the sound emitting device. The notch 54 shown in FIGS. 9-10 may facilitate retention in such embodiments. Removable coupling permits ready replacement of the ear tip or removal of the ear tip for cleaning. In other embodiments, the ear tip is permanently affixed to the sound emitting device by adhesive or other fastening means. Such a permanent coupling may be suitable where the ear tip is coupled to a disposable sound emitting device. A notch may not be required where the coupling is secured by an adhesive. In other embodiments the ear tip is coupled to a nozzle to form a subassembly that is subsequently coupled to some other portion of the sound emitting device.

In some embodiments described herein, the body member is devoid of a sound passage wherein the fluid-filled ear tip is configured as an ear plug. In these embodiments, the body member may be shaped and sized for insertion at least partially in the user's ear canal. Such ear plugs are useful to prevent sound or fluid from entering a user's ear canal during use. Ear plugs are commonly used by swimmers and persons subject to environmental noise among others. As described herein, the volume of fluid disposed in the internal chamber of the ear plug may be less than, equal to, or more than the nominal volume. Filling the internal chamber of the body member with a volume of fluid less than the nominal volume may provide improved comfort and performance.

Generally, the body member of the ear tip has a wall thickness defined by a distance between an exterior surface of the body member and an interior surface thereof. In some embodiments, the wall thickness of the body member is uniform throughout all portions of the body member. In other embodiments the wall thickness of different portions of the body member is non-uniform. In one example, a wall thickness of the portion of the body member configured to contact the user's ear is less than the wall thickness of other portions of the body member. Providing a thinner wall portion where the ear tip contacts the user's ear may improve comfort. In another example, the wall thickness of a portion of the body member defining the sound passage or a portion thereof is greater than the wall thickness of other portions of the body member. Providing a thicker wall portion where the hearing device is coupled to the sound passage may improve retention performance and robustness of the ear tip. FIG. 2 shows the body member having a first wall portion 34 having a first thickness 36 and a second wall portion 38 having a second thickness 40, wherein the first thickness 36 is greater than the second thickness 40. In other embodiments, production complexity and cost may be reduced by providing an ear tip having a uniform wall thickness.

A variable wall thickness in an ear tip configured as an ear plug may also be beneficial. In some ear plug embodiments it may be desirable to provide a thinner wall on portions of the ear plug that contact the user's ear and to provide a thicker wall at other portions of the ear tip for robustness. For example, a thicker wall portion may be formed on a trailing end portion of the ear tip that is frequently handled by the user when inserting and removing the ear tip. Alternatively, it may be desirable to provide a uniform wall thickness on all portions of the ear tip for cost and other reasons.

In alternative embodiments, the ear tip may be formed from materials having different hardnesses in lieu of, or in combination with, variable wall thicknesses. For example, a harder material may be used for the sound passage or a softer material may be used for the portion of the body member that contacts the user's ear. In these embodiments the body member may be formed in a multi-shot molding process among other processes.

In FIG. 4, the fluid-filled ear tip 10 and particularly the body member is sized and shaped for insertion at least partially into the user's ear canal. Upon insertion of the ear tip 10 into the ear canal, the exterior portion 18 of the body member engages a wall 50 of the ear canal wherein the fluid-filled ear tip conforms to a shape of the ear canal. The engagement between the body member and the ear canal also forms an acoustic at least a partial acoustic seal. As such, the fluid-filled ear tip reduces or prevents ambient noise from entering the ear canal of the user. The ear tip may also prevent sound (e.g., music, voice from a phone call, etc. provided to the user's ear canal) from propagating into the ambient environment.

In some embodiments, the ear tip is configured to be stretched and remain at least partially stretched for a sufficient duration to permit insertion of the stretched ear tip at least partially into the user's ear canal. In this embodiment, the stretched ear tip is readily disposed into the user's ear canal and more fully conforms to the ear canal as the stretched ear tips contracts in situ thereby providing an optimal seal. This feature is suitable for use with fluid-filled ear tips with a sound passage and for fluid-filled ear tips configured as ear plugs. This feature may also be used in combination with fluid-filled ear tips having fluid-filled volume that is less than the nominal volume, equal to the nominal volume or greater than the nominal volume.

In these embodiments, the viscosity of the fluid is selected to allow the fluid-filled elastic body member to be deformed into a stretched configuration and then to contract from the stretched configuration to an un-stretched configuration in a time frame that permits insertion of the stretched ear tip at least partially into the ear canal. The contraction time, or time frame, is a time required for the ear tip to contract from a stretched configuration to a substantially stable un-stretched configuration. Generally a higher viscosity fluid will have a longer contraction time whereas a lower viscosity fluid will have a shorter contraction time. The elasticity of the body member also bears on the contraction time. The contraction time also depends on the extent to which the ear tip is stretched. A fluid having a viscosity greater than 10,000 centipoise is generally suitable for the stretchable ear tip embodiments described herein. This lower limit is merely an example and is not intended to be limiting. Selection of a suitable viscosity and elasticity may readily be performed with minimal experimentation. In one embodiment, the contraction time of the stretched ear tip does not exceed 60 seconds. In another embodiment, the ear tip is configured so that the contraction time frame is between 5 seconds and 15 seconds.

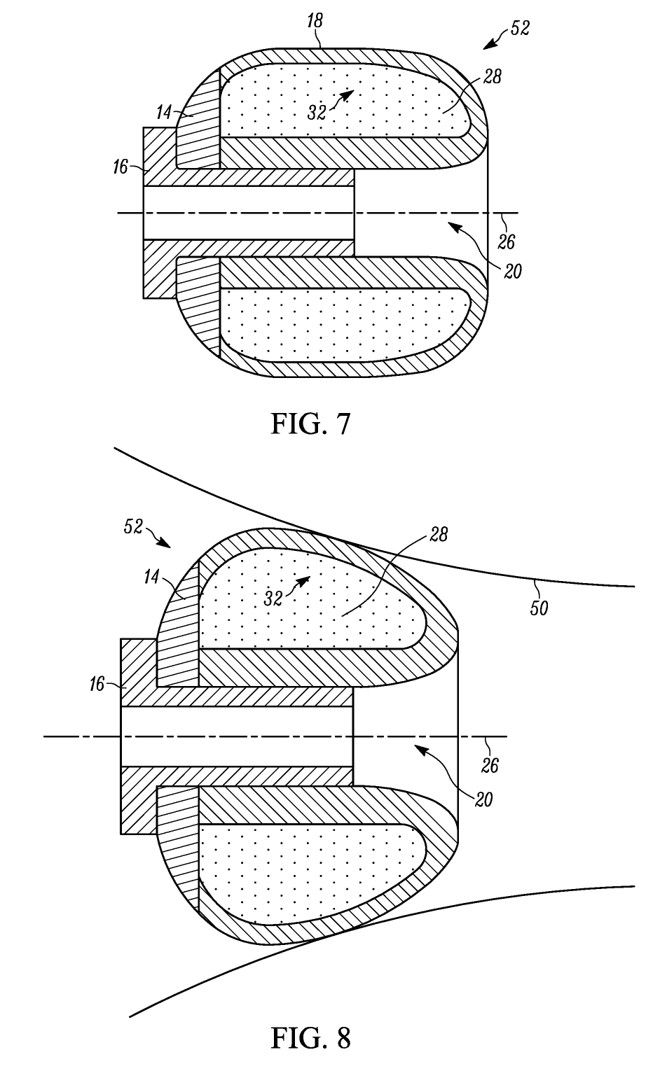

FIGS. 5-6 show a fluid-filled ear tip 52 in an un-stretched configuration characterized by a first diameter about the axial dimension and an un-stretched length along the axial direction. The fluid-filled body member may be stretched upon manipulation by the user. Such manipulation may be performed by squeezing and rolling the body member between the user's digits or by stretching the elastic body member. FIG. 7 shows the fluid-filled elastic body member in the stretched configuration. The stretched configuration is characterized by a second diameter about the axial dimension and a stretched length along the axial dimension. The first diameter of the un-stretched ear tip is greater than the second diameter of the stretched ear tip, and the stretched length is greater than the un-stretched length. Reducing the diameter of the body member by stretching or elongating it facilitates ready insertion of at least a portion of the ear tip at least partially into the user's ear canal when the body member is at least partially stretched. FIG. 8 shows the ear tip 52 disposed in the ear canal 50 after the ear tip has partially contracted to the un-stretched configuration. Upon partial contraction, the stretched body member assumes a partially stretched configuration conforming to the user's ear canal. The partially contracted ear tip also forms at least a partial seal with the user's ear canal.

In the ear tip of FIGS. 5-8, the fluid-filled body member has an internal chamber with a volume that is equal to the nominal volume. The performance of the stretchable ear tip may be improved by under filling the internal chamber as described herein. The ear tips in FIGS. 5-8 may also be configured with retention members as described herein in connection with FIGS. 9 and 10. The spout 16 in FIGS. 5-8 is typically part of the sound emitting device and may be permanently or removably coupled to the body member.

While the present disclosure and what is presently considered to be the best mode thereof has been described in a manner that establishes possession by the inventors and that enables those of ordinary skill in the art to make and use the same, it will be understood and appreciated that there are many equivalents to the exemplary embodiments disclosed herein and that myriad modifications and variations may be made thereto without departing from the scope and spirit of the disclosure, which is to be limited not by the exemplary embodiments but by the appended claims.

1. An ear tip comprising:
a body member forming an internal chamber,
the body member having an exterior portion configured to contact at least a portion of an ear of a user of the ear tip, the internal chamber having a nominal volume when the internal chamber is not deformed; and
a fluid disposed in the internal chamber of the body member,
a volume of the fluid-filled internal chamber is less than the nominal volume, wherein the fluid-filled internal chamber is deformed.

2. The ear tip of claim 1 is for coupling to a sound emitting device, the ear tip further comprising a sound passage through the body member, the sound passage having a sound inlet and a sound outlet.

3. The ear tip of claim 2, wherein the volume of the fluid-filled internal chamber is 40 percent to 90 percent of the nominal volume.

4. The ear tip of claim 2, wherein the volume of the fluid-filled internal chamber is 60 percent to 70 percent of the nominal volume.

5. The ear tip of claim 2, wherein the fluid has a viscosity of 1 centipoise to 10,000,000 centipoise.

6. The ear tip of claim 2, wherein the fluid is a viscous non-Newtonian fluid.

7. The ear tip of claim 2, wherein a distance between an exterior surface of the body member and an interior surface of the body member defines a wall thickness of the body member, the body member including a first wall portion having a first thickness and a second wall portion having a second thickness less than the first thickness, wherein the exterior portion configured to contact at least a portion of the ear of the user of the ear tip includes the second wall portion.

8. The ear tip of claim 7, wherein the body member has a quasi-toroidal portion disposed about an axial dimension of the sound passage, wherein the volume of the fluid-filled internal chamber is 40 percent to 90 percent of the nominal volume.

9. The ear tip of claim 8, wherein the body member has a hardness between 5 Shore A Durometer and 50 Shore A Durometer.

10. The ear tip of claim 8, wherein the body member comprises different parts wherein each of the different parts has a different hardness.

11. The ear tip of claim 1, further comprising a cap coupled to the body member, the cap configured to seal the fluid inside the internal chamber.

12. The ear tip of claim 2,
wherein the body member is elastic and the sound passage has an axial dimension,
the fluid-filled elastic body member having an un-stretched configuration characterized by a first diameter about the axial dimension and an un-stretched length along the axial dimension,
the fluid-filled elastic body member having a stretched configuration characterized by a second diameter about the axial dimension and a stretched length along the axial dimension, the first diameter greater than the second diameter and the stretched length greater than the un-stretched length,
wherein the fluid has a viscosity that allows the fluid-filled elastic body member to be inserted at least partially into the ear canal of a user before the fluid-filled elastic body member contracts to the un-stretched configuration.

13. The ear tip of claim 1 is an ear plug having an axial dimension,
the fluid-filled elastic body member having an un-stretched configuration characterized by a first diameter about the axial dimension and an un-stretched length along the axial dimension,
the fluid-filled elastic body member having a stretched configuration characterized by a second diameter about the axial dimension and a stretched length along the axial dimension, the first diameter greater than the second diameter and the stretched length greater than the un-stretched length,
wherein the fluid has a viscosity that allows the fluid-filled elastic body member to be inserted at least partially into the ear canal of a user before the fluid-filled elastic body member contracts to the un-stretched configuration.

14. An ear tip comprising:
an elastic body member forming an internal chamber, the body member having an exterior portion configured to contact at least a portion of an ear canal of a user of the ear tip;
a fluid disposed in the internal chamber of the elastic body member,
the fluid-filled elastic body member having an un-stretched configuration characterized by a first diameter about the axial dimension and an un-stretched length along the axial dimension, the fluid-filled elastic body member having a stretched configuration characterized by a second diameter about the axial dimension and a stretched length along the axial dimension, the first diameter greater than the second diameter and the stretched length greater than the un-stretched length,
wherein the fluid has a viscosity that allows the ear tip to be inserted at least partially into the ear canal of a user before the fluid-filled elastic body member contract to the un-stretched configuration.

15. The ear tip of claim 14, wherein the fluid-filled elastic body member contracts from the stretched configuration to a substantially unstretched configuration in a time frame that permits insertion of the ear tip at least partially into a user's ear canal before the fluid-filled elastic body member contracts to the un-stretched configuration.

16. The ear tip of claim 15, wherein the time frame does not exceed 60 seconds.

17. The ear tip of claim 15, wherein the time frame is between 5 seconds and 15 seconds, wherein the fluid-filled elastic body member assumes an intermediate stretched configuration conforming to the user's ear canal after the ear tip is inserted at least partially into the ear canal before expiration of the time frame.

18. The ear tip of claim 15, a first wall portion of the body member forming the sound passage having a first thickness and a second wall portion of the body member forming the exterior portion configured to contact at least a portion of a user's ear canal having a second thickness less than the first thickness.

19. The ear tip of claim 14,
the internal chamber having a nominal volume when the internal chamber is not deformed,
the internal chamber having a volume that is 40 percent to 90 percent of the nominal volume when fluid is disposed in the internal chamber, wherein the fluid-filled internal chamber is deformed.

20. The ear tip of claim 14 is for use with a sound emitting device, the ear tip further comprising a sound passage having an axial dimension disposed through the elastic body member, the sound passage having a sound inlet portion and a sound outlet portion, wherein the sound inlet portion is configured to detachably couple to a sound emitting device.
